(19) United States
(12) Patent Application Publication
(10) Pub. No.: US 2021/0342424 A1
(43) Pub. Date: Nov. 4, 2021

(54) SYSTEM, PLATFORM AND METHOD FOR TRANSFERING USERS BETWEEN VIRTUAL ROOMS

(71) Applicant: CLICKTO LTD., Tel Aviv (IL)

(72) Inventors: Dotan Tamir, Tel Aviv (IL); Shaham TAMIR, Mazkeret Batya (IL)

(73) Assignee: CLICKTO LTD.

(21) Appl. No.: 17/306,046

(22) Filed: May 3, 2021

Related U.S. Application Data
(60) Provisional application No. 63/018,638, filed on May 1, 2020.

(51) Int. Cl. G06F 21/31; H04L 12/18; G06F 9/445; G06Q 10/10; G06Q 20/12

(52) U.S. Cl. CPC G06F 21/31; H04L 12/1822; H04L 12/1818; G06Q 50/2053; G06Q 10/1095; G06Q 20/127; G06F 9/44526

(57) ABSTRACT

There is provided, in accordance with an embodiment of the present invention, a system, platform and methods to provide enhanced virtual meeting management. The system may include a system management console; a program management console; and a participant navigation module, wherein the system management console provides a user with a single personalized link (SPL), and wherein the program management console provides automated access to multiple secured virtual meetings as per the participant's selected schedule, using the SPL, and wherein the participant trafficking module enables automated transfers of the user to appropriate virtual meetings based on the participant's predefined schedule.

### CROSS-REFERENCE TO RELATED APPLICATIONS

This application claims priority from U.S. Provisional Patent Application No. 63/018,638, filed 1 May 2020, entitled “SYSTEM, PLATFORM AND METHOD FOR TRANSFERRING USERS BETWEEN VIRTUAL ROOMS”, which is incorporated in its entirety herein by reference.

### FIELD OF THE INVENTION

The present invention relates in general to systems and methods useful in supporting virtual room services, and in particular, supporting remote educational services.

### BACKGROUND OF THE INVENTION

Currently, remote users of virtual rooms are generally required to use a specific link for each virtual room they would like to join. It's up to the user to actively go to another room if they want to move to another meeting.

Some virtual room companies such as Zoom Meetings and Microsoft Teams provide a Lobby or Waiting Room feature. Some virtual rooms technologies feature Breakout Rooms, which allow the host to randomly or manually transfer the participants of a specific meeting to separate rooms.

Some companies also offer a calendar integration, by which a virtual room link is created for every meeting on the calendar. Most virtual room companies allow using a guest list, and a unique authentication key per user for entering a specific meeting or room.

The systems described above are only treating the room entrance mechanism based on the request of the user and based on a predefined list of guests.

It would be highly advantageous to have a system or method that could enable virtual room usage based on a predefined schedule, which is specific for the user.

### SUMMARY OF THE INVENTION

According to at least some embodiments, a system, platform and methods are described herein to provide enhanced virtual meeting management.

There is provided, in accordance with an embodiment of the present invention, a system, platform and methods to provide enhanced virtual meeting management. The system may include a system management console; a program management console; and a participant navigation module, wherein the system management console provides a user with a single personalized link (SPL), and wherein the program management console provides automated access to multiple secured virtual meetings as per the participant's selected schedule, using the SPL, and wherein the participant navigation module enables automated transfers of the user to appropriate virtual meetings based on the participant's predefined schedule.

According to further embodiments, the system further includes a payment module for facilitating payment of virtual meeting enrolment according to participant selections, wherein the participant navigation module is adapted to allow or refuse participant entry to virtual meetings in accordance with the payment for virtual meeting enrolment.

According to further embodiments, the system further includes code to run in the background of all user activities to determine user authentication for attendance to a current activity.

According to further embodiments, the system further includes a plug and play Application to be run on a browser of a communications device to facilitate registration, scheduling, attendance and management of virtual meetings.

According to further embodiments, the system further includes a downloadable dedicated software Application to be run on a smart communications device to facilitate registration, scheduling, attendance and management of virtual meetings.

There is provided, in accordance with an embodiment of the present invention, a platform for managing live scheduling of virtual activities, comprising: an electives module; a module providing scheduled content boards; a module enabling participation on demand; and a module for enabling partial participant assignments.

There is provided, in accordance with an embodiment of the present invention, a method for managing attendance of virtual programs, comprising: creating a new participant in a virtual program system, and providing the new participant with a Personal Access Link (PAL); scheduling one or more activities for the participant, based on the participant's selected program type; enrolling the participant, based on the participant's enrolment type;

providing the participant with a virtual program entrance page for entering of PAL; verifying and authenticating the user's PAL prior to allowing participant entry into the virtual program; redirecting the participant to one or more virtual meeting rooms, based on the participant's schedule; and logging the participant out of a virtual program when the participant enrolment determines such, by disactivating the user PAL.

According to further embodiments, the method includes providing a user Application that facilitates automatic transfers between meetings according to participant schedules.

According to further embodiments, the method includes providing an Application that facilitates user customized enrolment into one or more of virtual meetings, virtual programs, and virtual camps.

According to further embodiments, the method includes providing an application that facilitates user payment for selected meetings or programs.

According to further embodiments, the method includes providing an application that facilitates user payment based on user participation in one or more virtual meetings or programs.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic system diagram depicting components of the VRPN system, including a Super Admin management console, a Camp management console, and a Camp management console, according to some embodiments;

An example of a workflow for a staff member log in is shown in FIG. 2, according to some embodiments;

An example of a workflow for adding a staff member is shown in FIG. 3, according to some embodiments;

An example of a workflow for editing a staff member is shown in FIG. 4, according to some embodiments;

An example of a workflow for deleting a staff member is shown in FIG. 5, according to some embodiments;

An example of a workflow for adding a virtual space is shown in FIG. 6, according to some embodiments;

An example of a workflow for entering a virtual space as a guest is shown in FIG. 7, according to some embodiments;

An example of a workflow for adding an activity is shown in FIG. 8, according to some embodiments;

An example of a workflow for activating a session is shown in FIG. 9, according to some embodiments;

A screenshot of an example of a dashboard, or an admin type scheduling GUI, can be seen in FIG. 10, according to some embodiments;

Screenshots of examples of scheduling boards, for example admin type GUI's, can be seen in FIGS. 11A-11D and 12-16, according to some embodiments;

FIGS. 17A-17B show screenshots of examples of setting and scheduling electives are shown, according to some embodiments;

Detailed examples of a workflows relating to Personal Access Links (PAL) are shown in FIGS. 18-20, according to some embodiments;

A detailed example of a workflows relating to smart user enrollment is shown in FIG. 21A, according to some embodiments;

Screenshots of examples of participant user type enrollment related GUI's can be seen in FIGS. 21B-21E, according to some embodiments;

Screenshots of examples of live schedules, for example, staff type GUI's, can be seen in FIGS. 22A-22C, 23 and 24, according to some embodiments;

FIG. 25 shows an example of a screenshot showing a sample Analytics type attendance report for admins, according to some embodiments;

FIGS. 26A-26C show an example of a screenshot showing a sample content board, according to some embodiments; and

A detailed example of a workflow relating to an example of a participant schedule and navigation process is shown in FIG. 27, according to some embodiments.

### DETAILED DESCRIPTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The term “virtual rooms” as used herein refers to chat rooms or online conferencing rooms, and is primarily used to describe any form of synchronous conferencing or asynchronous conferencing to enable substantial real-time online chat and/or video and online interaction with strangers or remote users, to fully immersive graphical social environments.

According to some embodiments of the present invention, a virtual room personalized navigation (hereinafter referred to as VRPN) system, platform and method are provided that takes multiple remote users between scheduled virtual meetings, based on characteristics such as activity name, room name, group assignment, and time range, optionally to enable virtual room usage based on a predefined schedule, which is specific for the user, and was set by a program admin.

In some embodiments, the VRPN system is useful for hosting virtual educational programs, for example summer camps, conferences, schools, after-school programs, seminars, and youth movement activities, etc. These kinds of programs are usually managed in groups, where each group or individual has their own specific timeline. In some activities there is only one group, and in some there are many groups together, or even all the groups together. What's common for many of those programs, is that the user's assignment is mostly strict. The program is planned to support each group based on its schedule, with the appropriate type and amount of staff and/or resources. In these cases, it is crucial to have a system that can support automatically transferring all the participants to their scheduled activities.

The recent coronavirus spread effect forced educational program to move to virtual rooms, and proved that the existing technologies are far from imitating the programmatic structure of an in-person program. For example, a summer camp program typically has a schedule of activities for each group (based on age, gender etc.), which rotates from day to day. Each group moves between activities, spaces and program staff. Virtual room technologies typically provide participants with separate links, adding them manually to each virtual room, and telling them to manually go to a room at a specific time.

Further, since the participants at virtual programs are usually at their homes, and the authority of the program admin is limited, less savvy users may often lose users, and make transfers to different or new sessions difficult and not user friendly.

Non-limiting embodiments of the present invention include a system, method and/or means for facilitating online virtual room programs, such as educational programs and more. In particular, some embodiments of the present invention navigate or assist the user in moving between virtual rooms or meetings, preferably based on a schedule of meetings, with characteristics such as activity name, room name, group assignment, and time range.

There is provided, in accordance with an embodiment of the present invention, an apparatus, system, and method to allow a program admin to assign meeting rooms for a list of groups, for specific time slots, with additional characteristics for that schedule block. This assignment can be done for many time slots on the same day, or on different days, which all together represent the group's schedule for the session.

According to further embodiments, virtual camps, schooling, courses, training etc. may be provided to end users or participants, by being broken down into sessions or combination of sessions to which users can enroll and thereafter be authenticated and directed.

These virtual sessions may be supported by a smart scheduling functionality that may include, for example, scheduling of sessions in virtual Rooms using Personal Access Links for users, that functions as permanent links to allow users customized and authenticated access to sessions, to record sessions, to coordinate group activities, and enable automated scheduling per room/activity/group etc. These Personal Access Links may function as permanent or session-based unique participant identifiers.

Personal Access Links may also be used for automated assignment of staff to groups, meetings, rooms etc., and the automated transfer of users or participants in a camp or program to the designated virtual rooms or program facilities.

In further embodiments, smart scheduling of groups of participants may be provided, to direct multiple users to fixed and/or elective program options, to provide customized content to one or more users, etc.

In some embodiments, user access links may be provided for program electives, which may be part of a different scheduling layer, to enable provision of specific content, on-demand content, personalized content etc. to one or more appropriate and authenticated users.

In further embodiments, a system manager or admin may manage user links, for example, to limit access for specific times or for selected intervals of time. In some examples, links may expire at selected times, thereby logging the user out of a session or the system.

In further embodiments, the system may facilitate payment control for users, as per the user enrolment or registration options. For example, the user may be able to pay for full enrolment, part time enrolment, limited session enrolment, enrolment in electives or additional programs etc. for limited enrolment. Helps manage the user registration. In some cases, a system is provided for virtual room enrolment management to facilitate participant payment per courses, programs, activities etc.

In some embodiments the participant may be charged in App for courses selected. In some embodiments the participant may be charged after the attendance of courses, depending on their participation, access rights, usage of facilities etc. In still further embodiments, the system may facilitate entry of participants on-demand for specific programs or sessions, optionally using non-permanent or one time usage links. In some embodiments users may purchase coupons or rights to attend a selected number or type of sessions.

In still further embodiments, an Application may be provided to manage remote schooling programs, youth programs, university or high study programs, virtual conferences, networking meetings, or other suitable camps, programs etc.

Once the program admin is ready, in some embodiments, the VRPN system may send to each user a unique authentication link, referred to hereinafter as a Single Personal Link (SPL). This SPL is designed to always take the user to the virtual room that matches their group and current day and time as scheduled by the admin. If there is no room assigned for the current time, the VRPN system may show the user when is their next scheduled activity, and when that time arrives—it automatically transfers the user to the appropriate room. In some embodiments, the VRPN recognizes the user ID based on the connected database, based on the user's SPL, and matches them to the schedule assignment.

In some embodiments, the VRPN system does not allow entrance to any room for users who are not authenticated, or flagged as suspended by the program admin. In some embodiments, the VRPN system logs the user into the room with their first and last name automated from the user database.

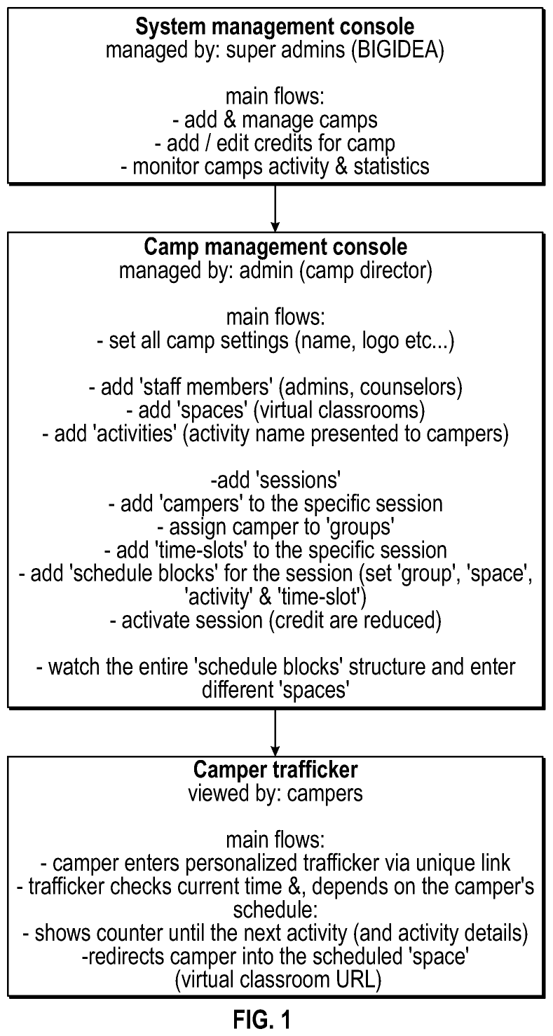

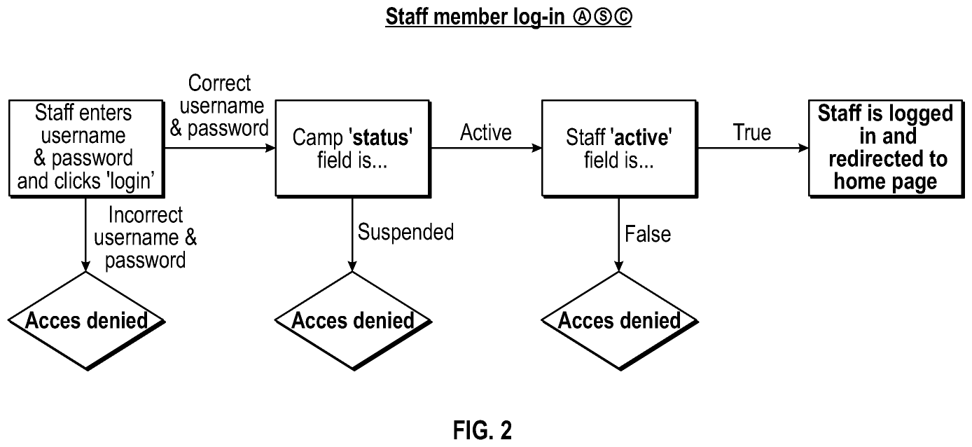

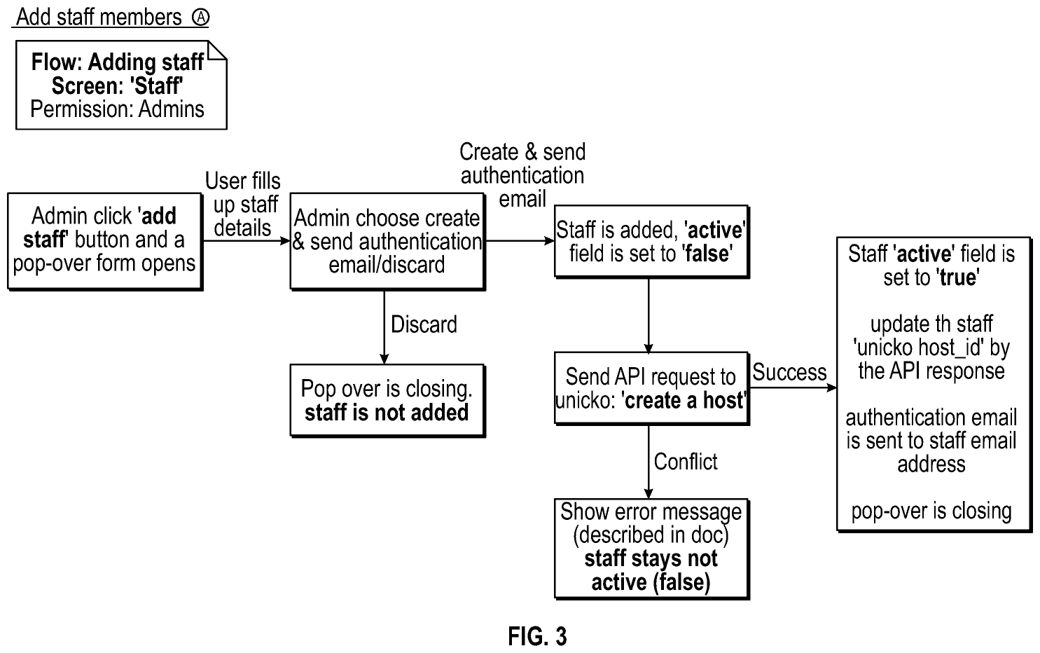

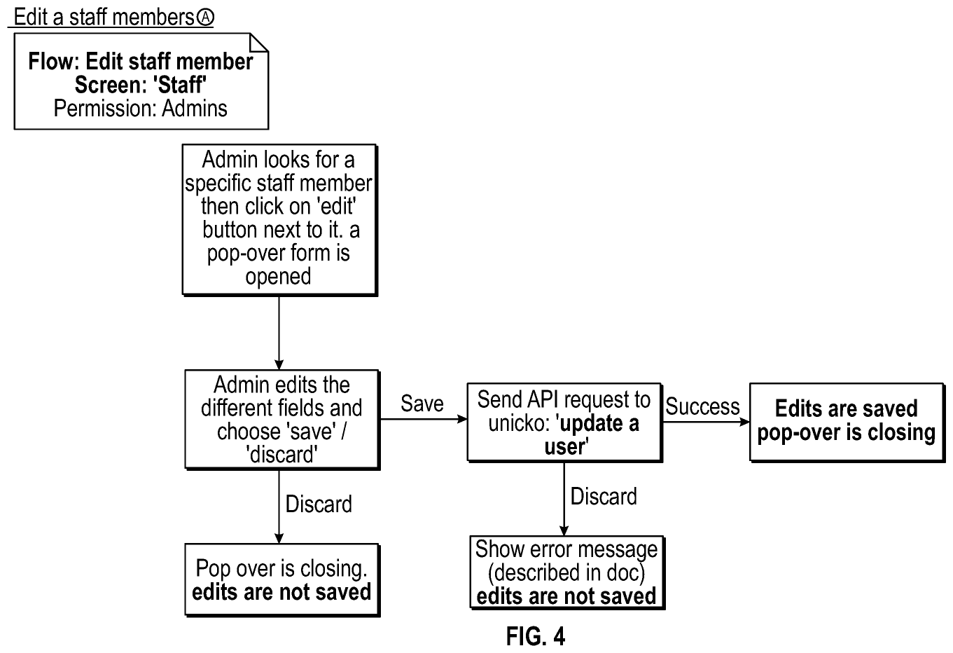

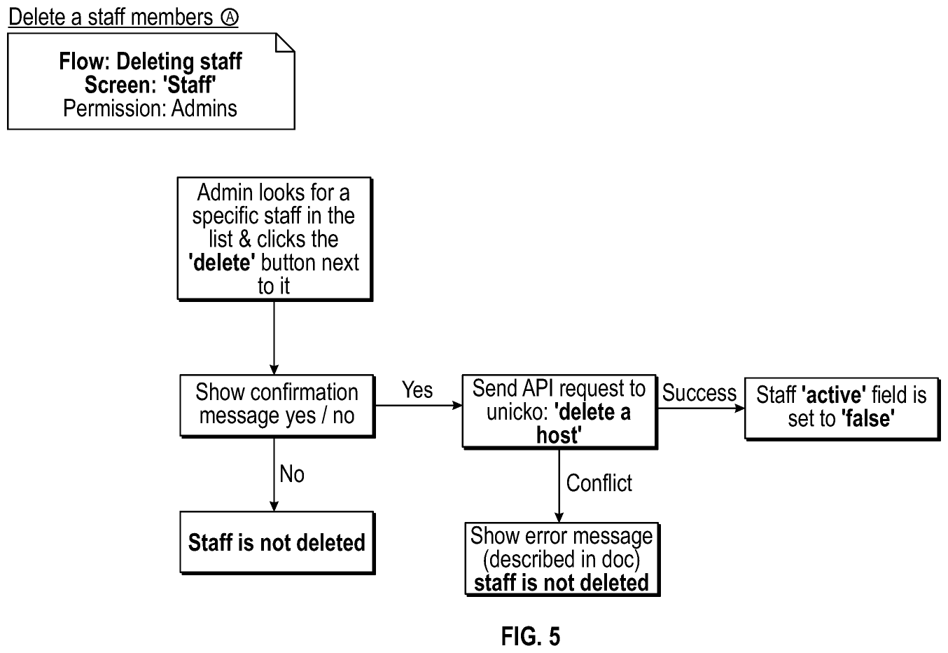

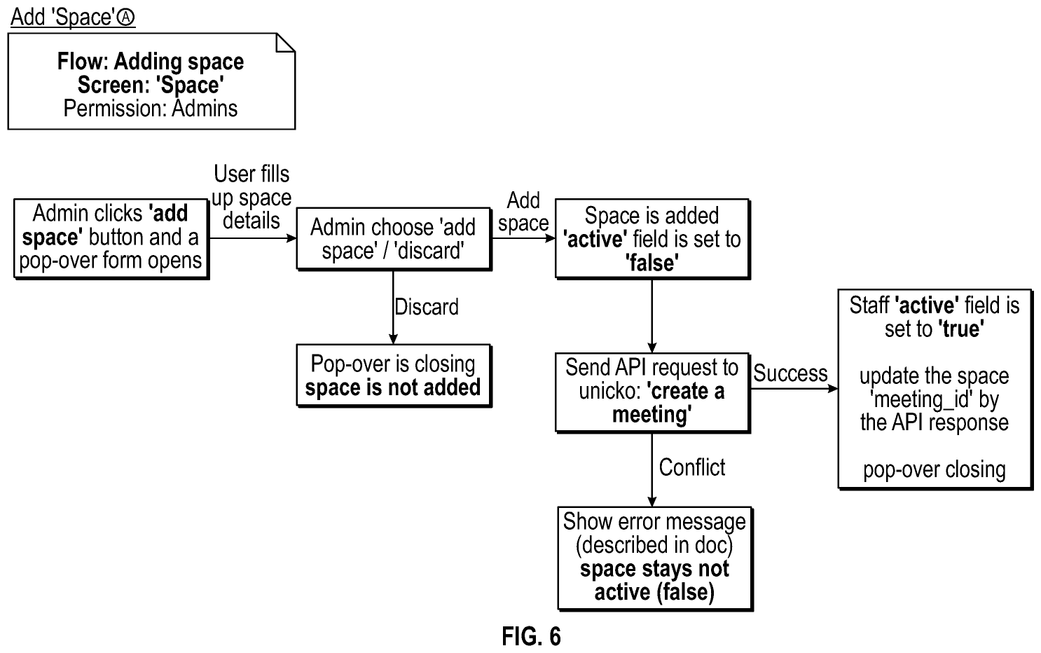

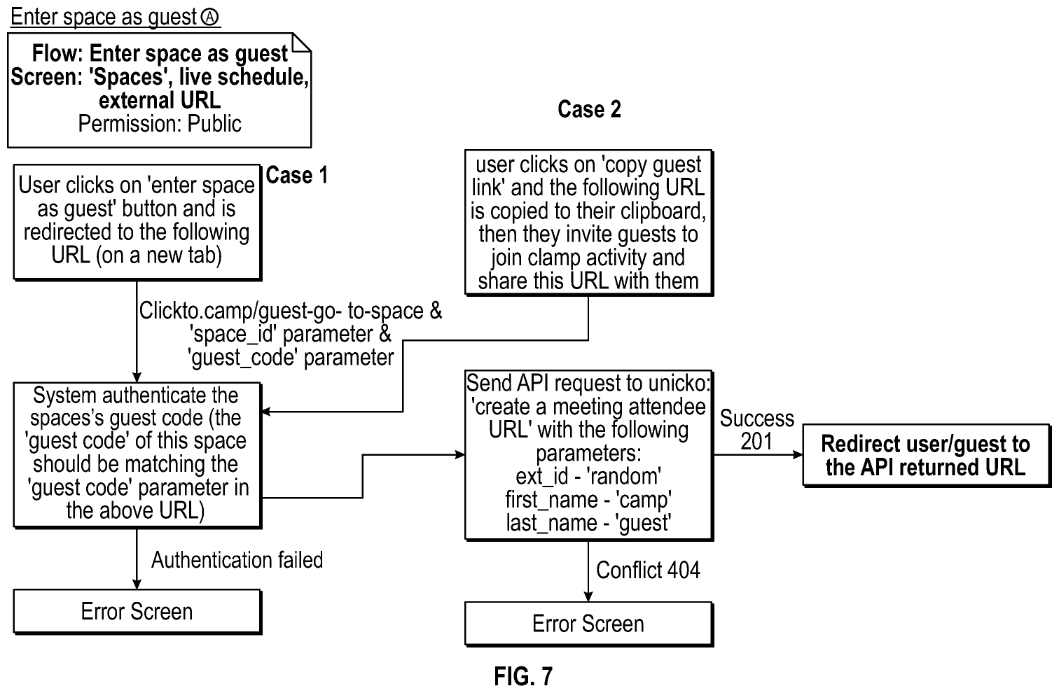

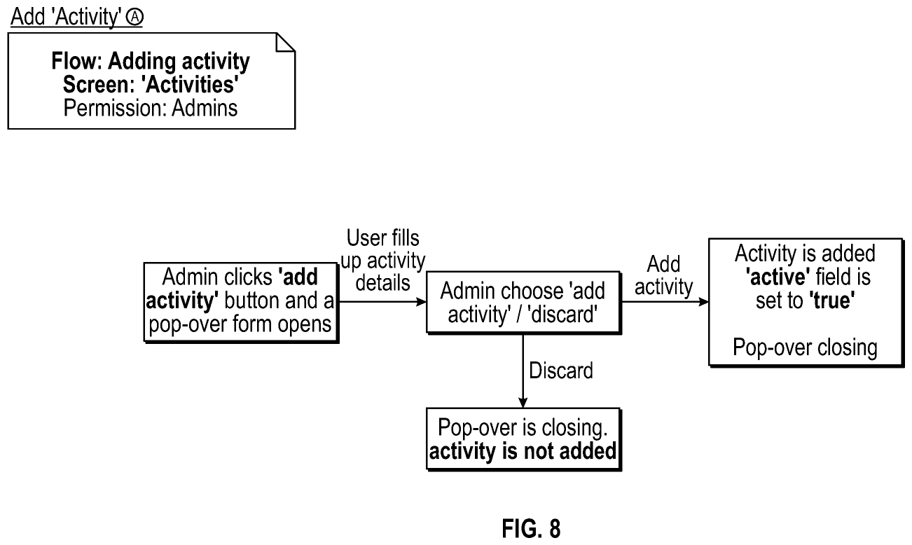

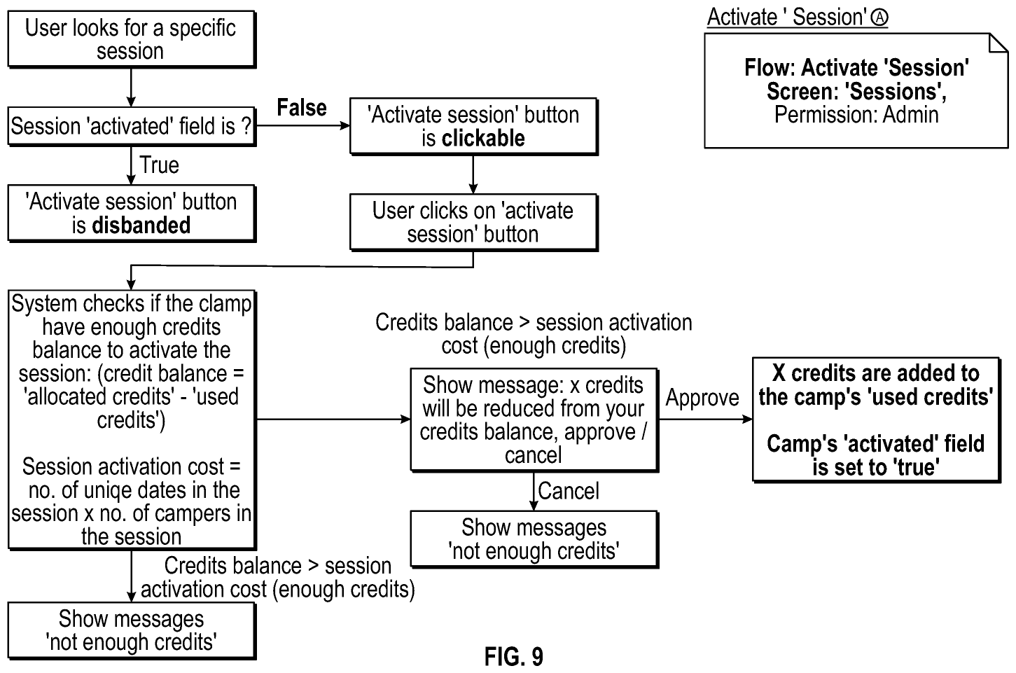

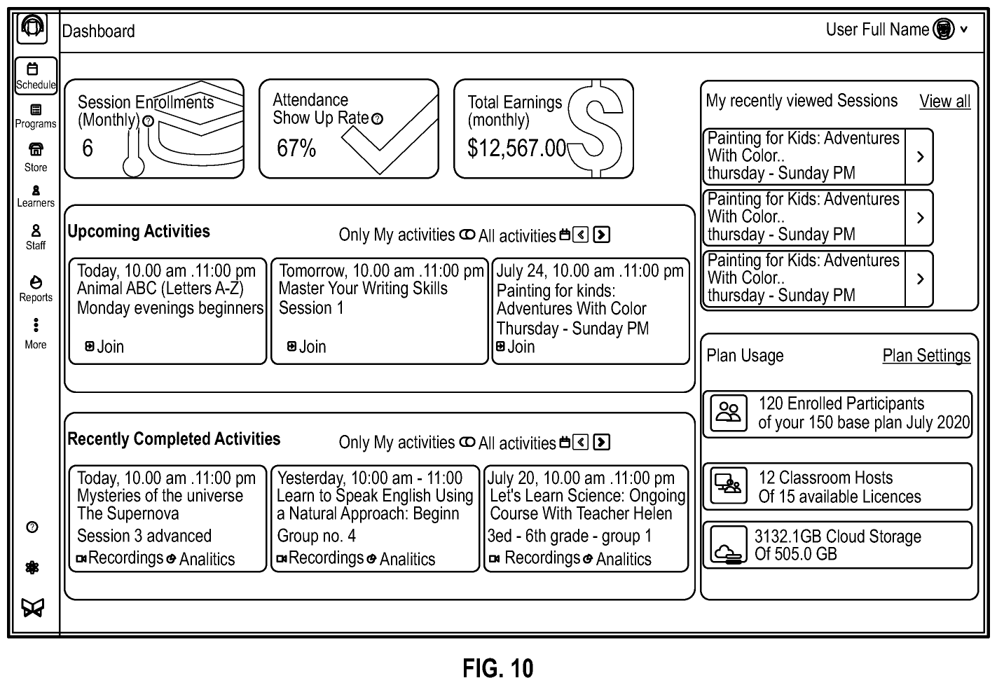

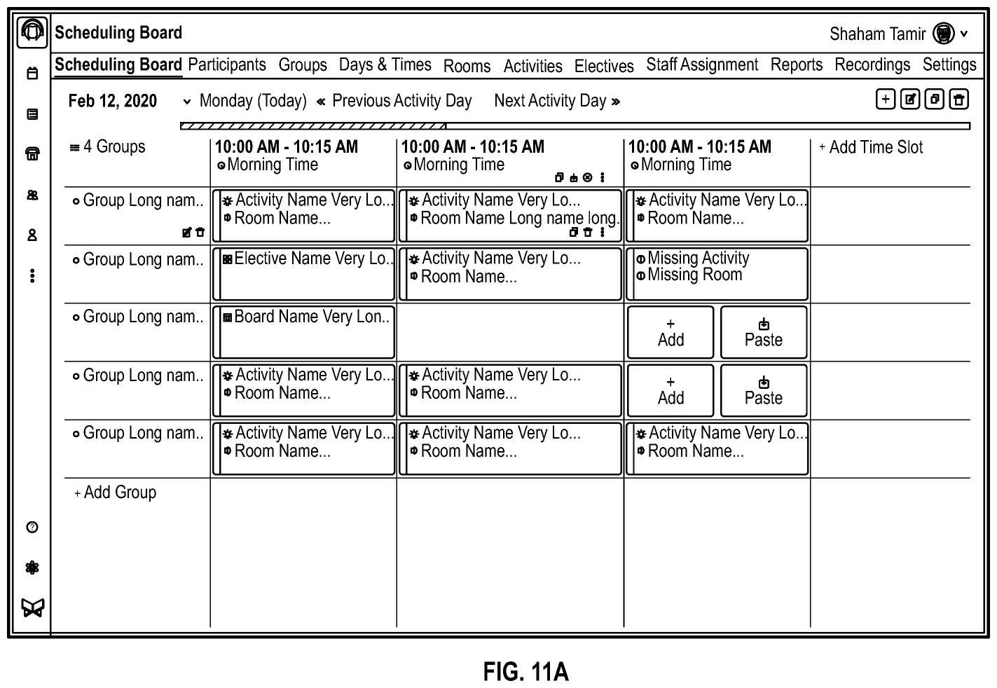

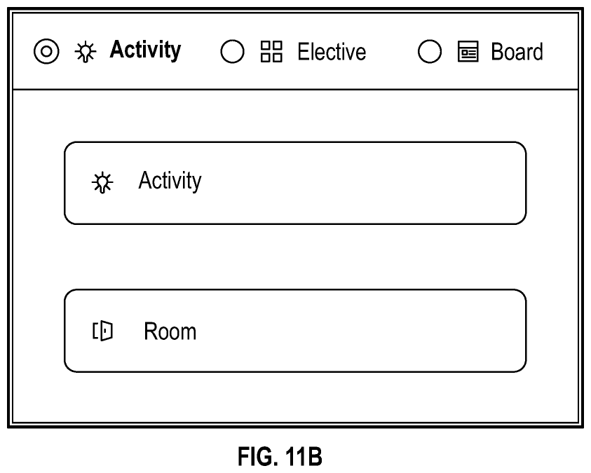

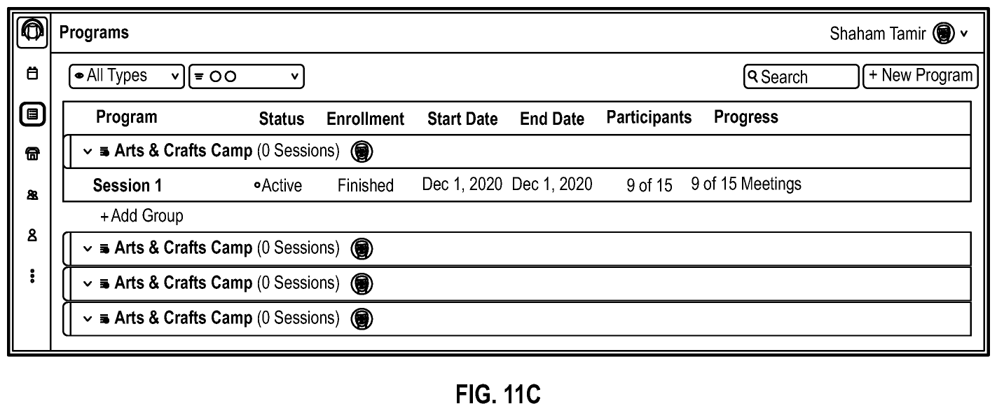

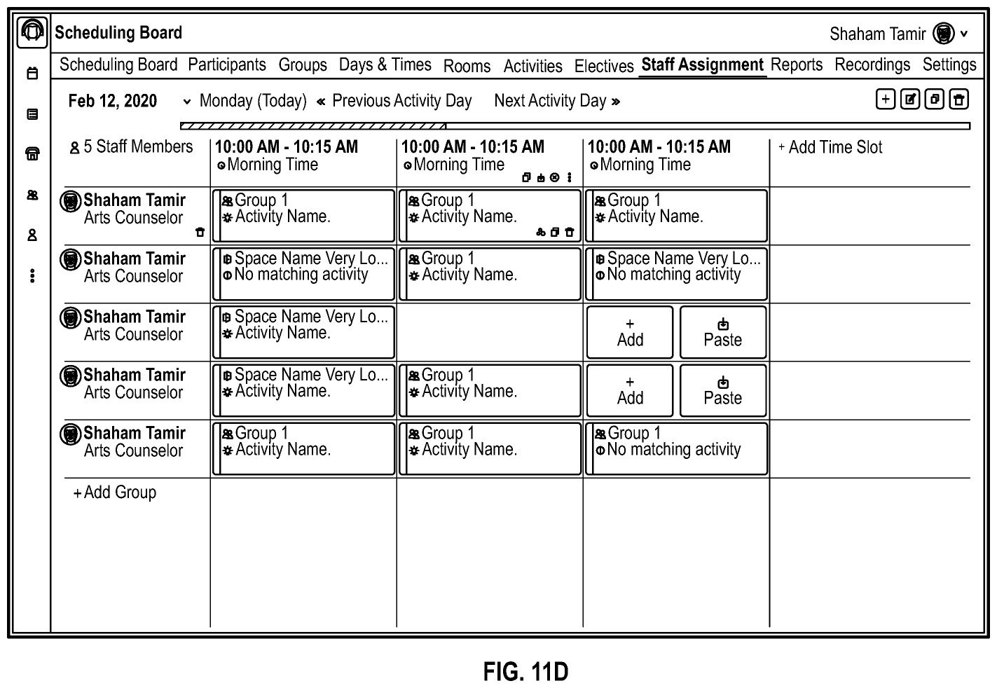

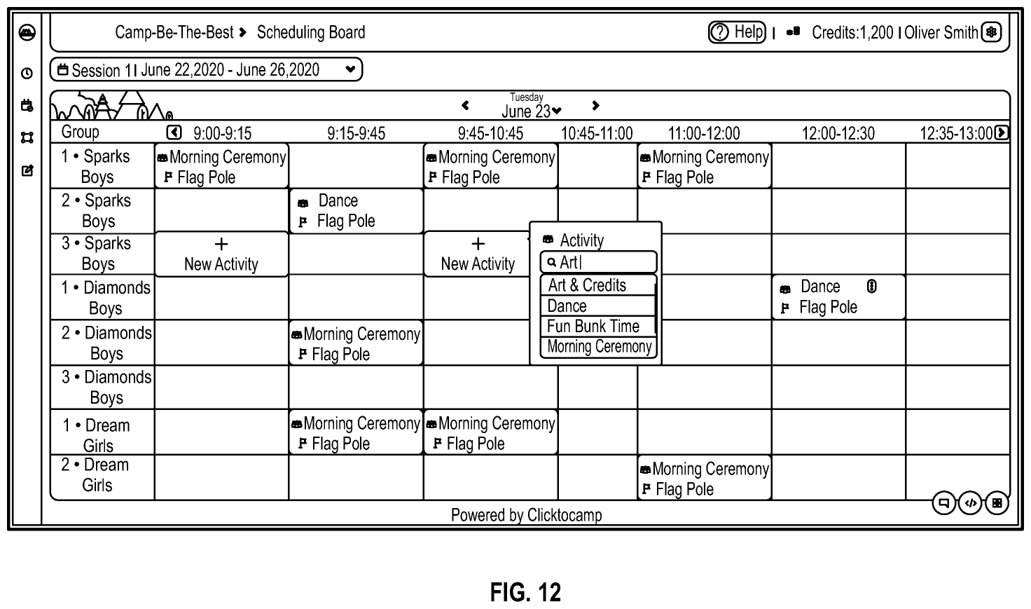

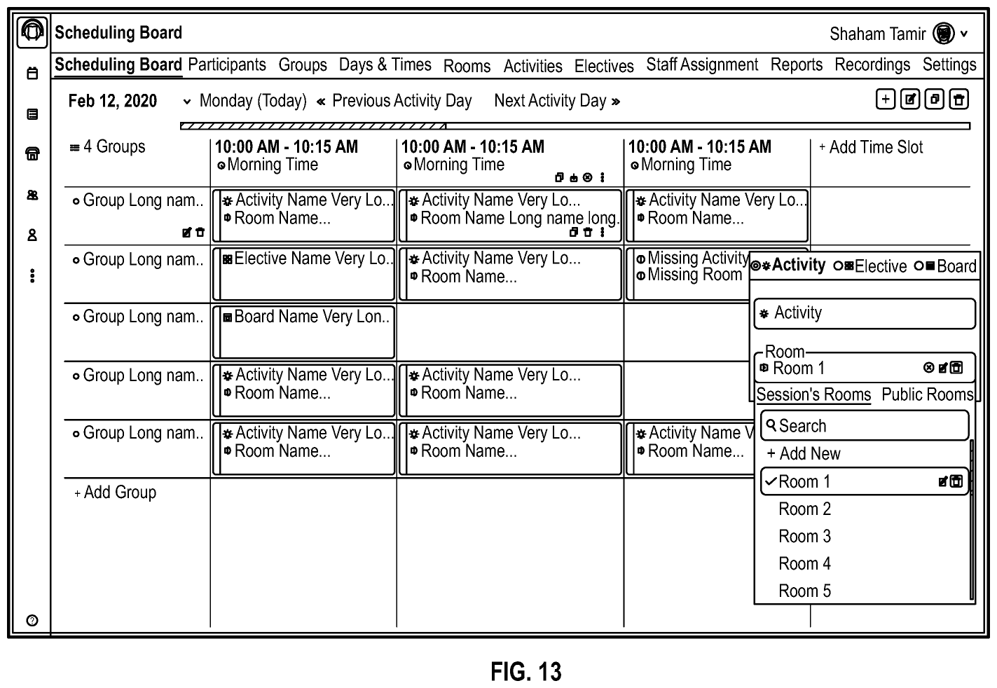

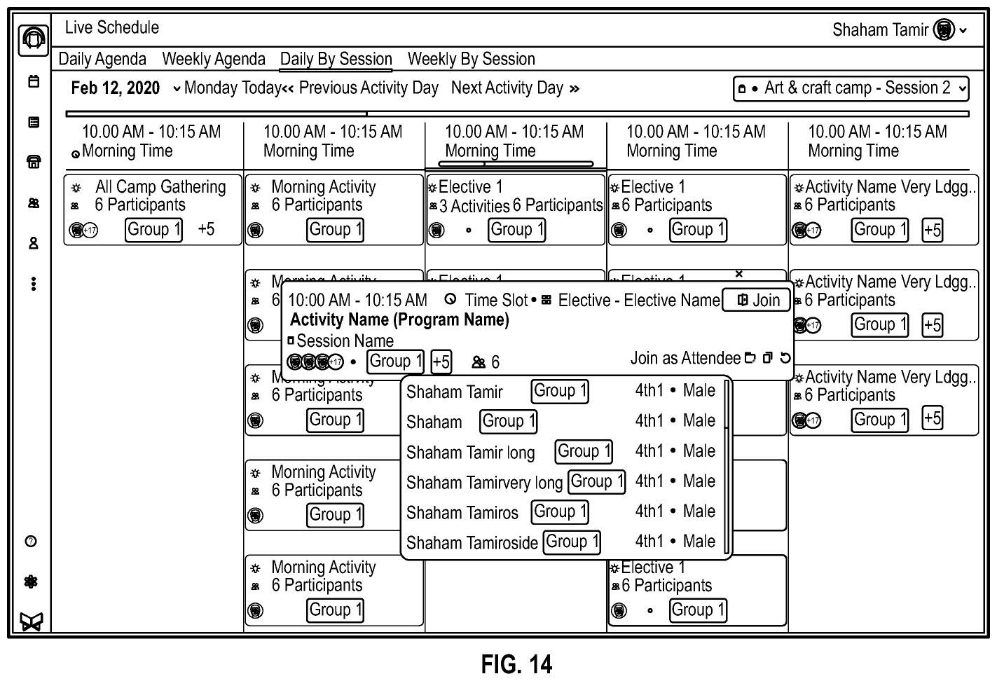

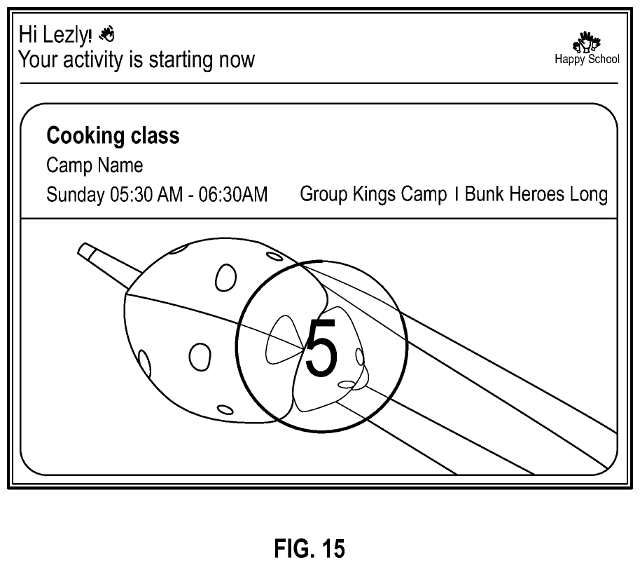

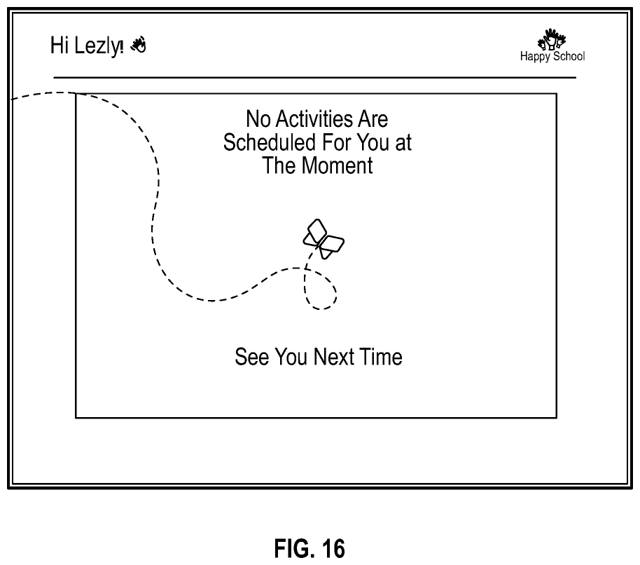

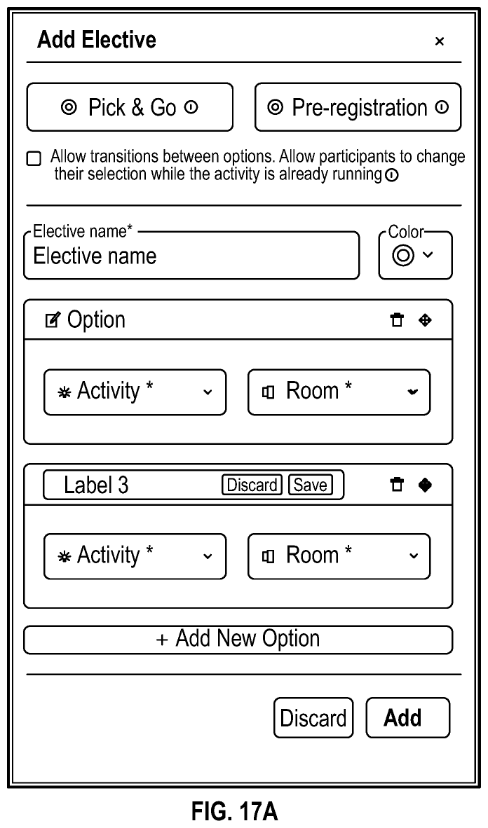

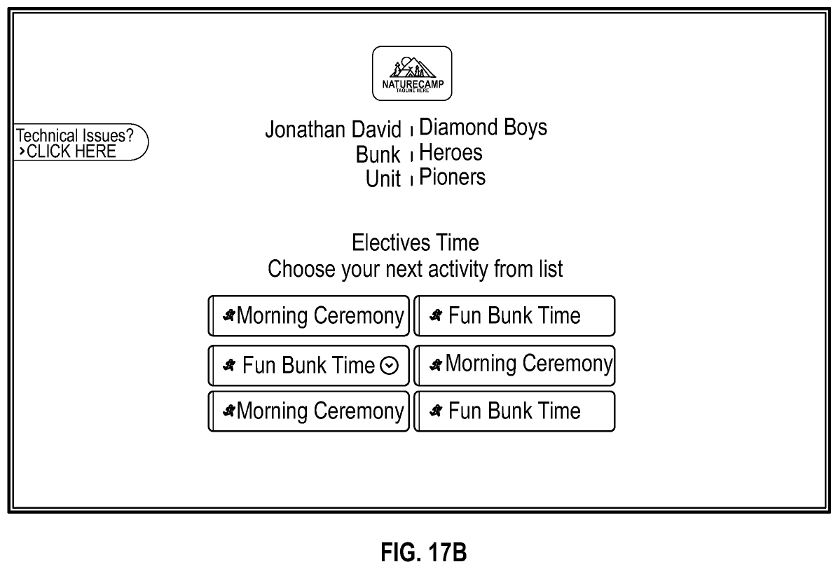

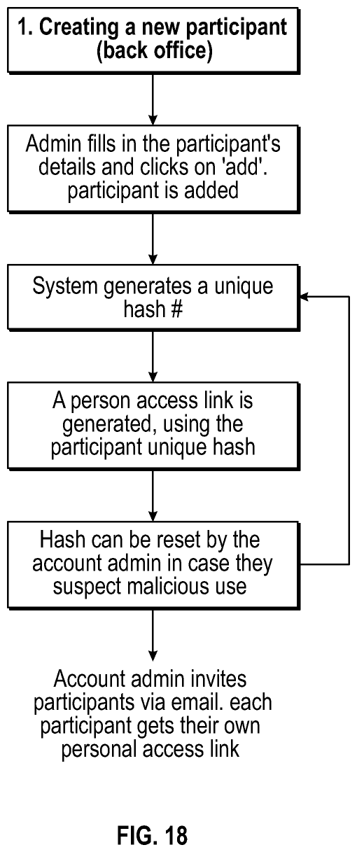

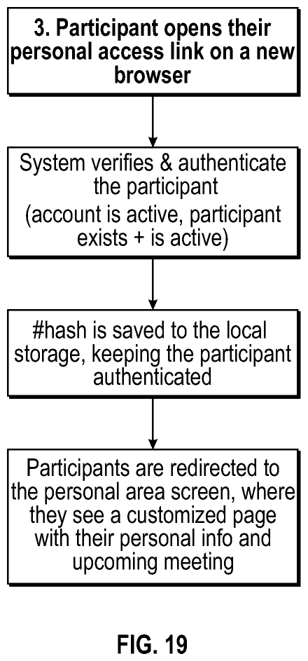

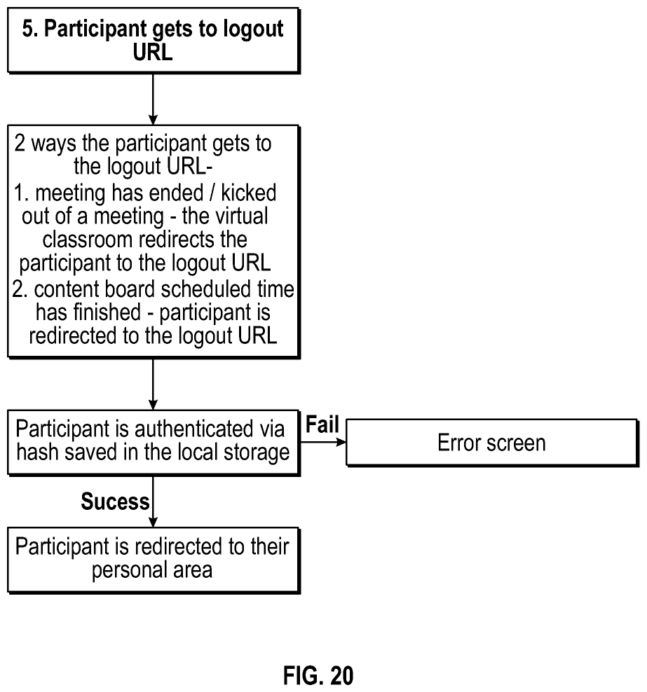

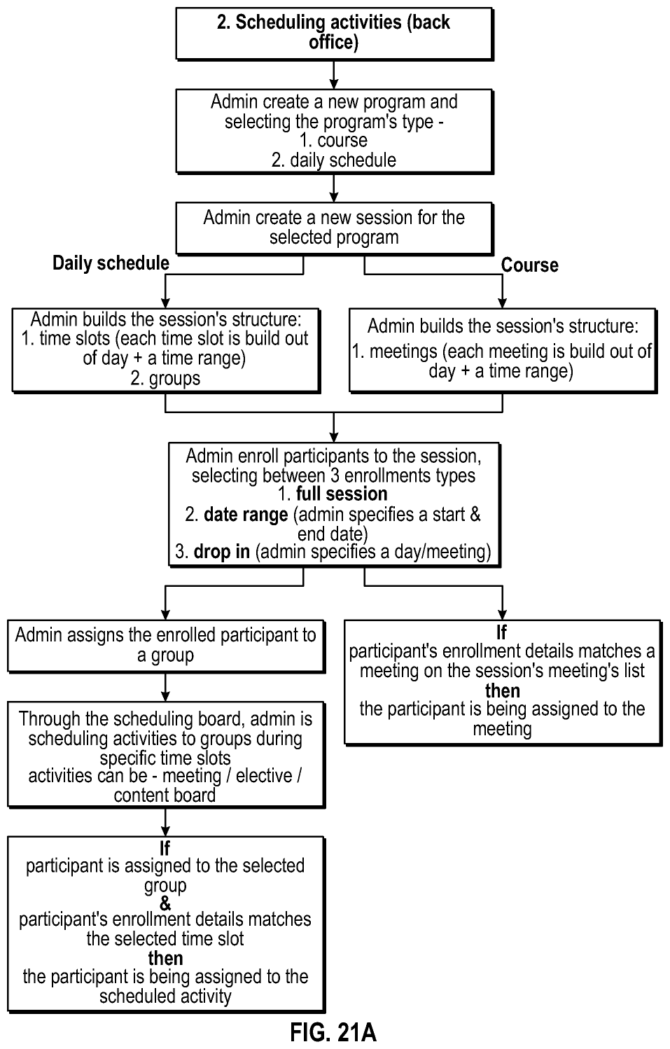

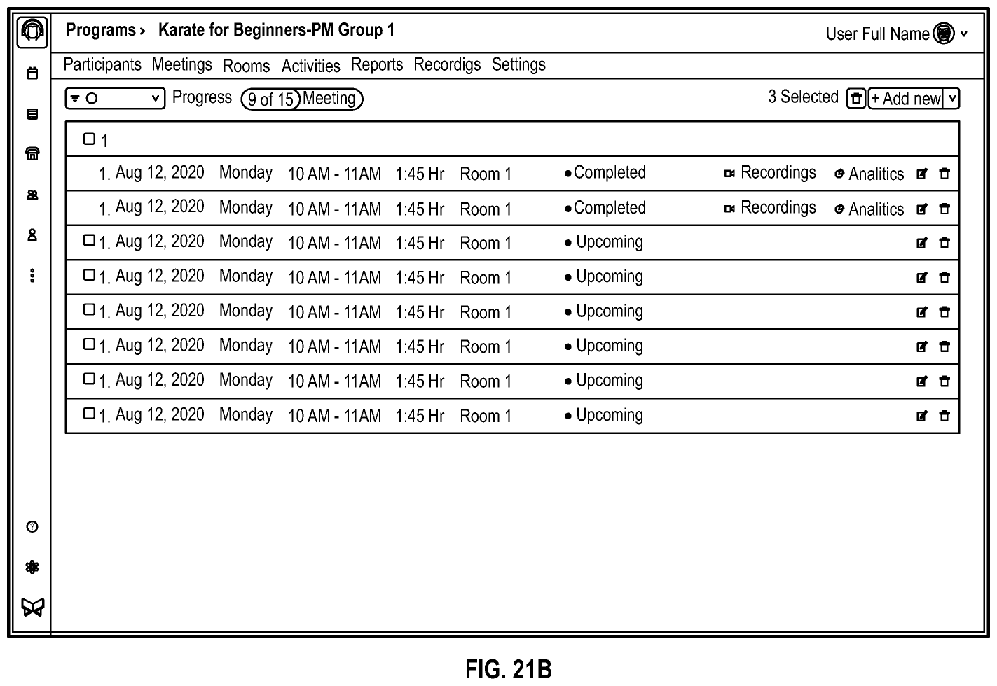

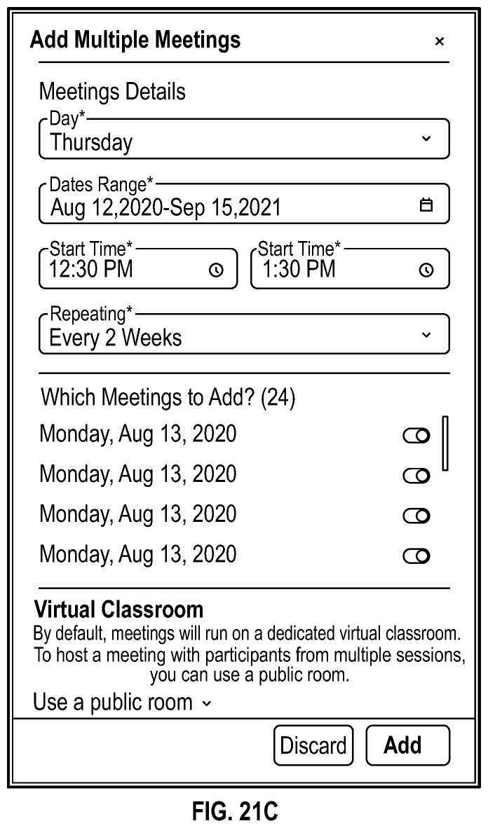

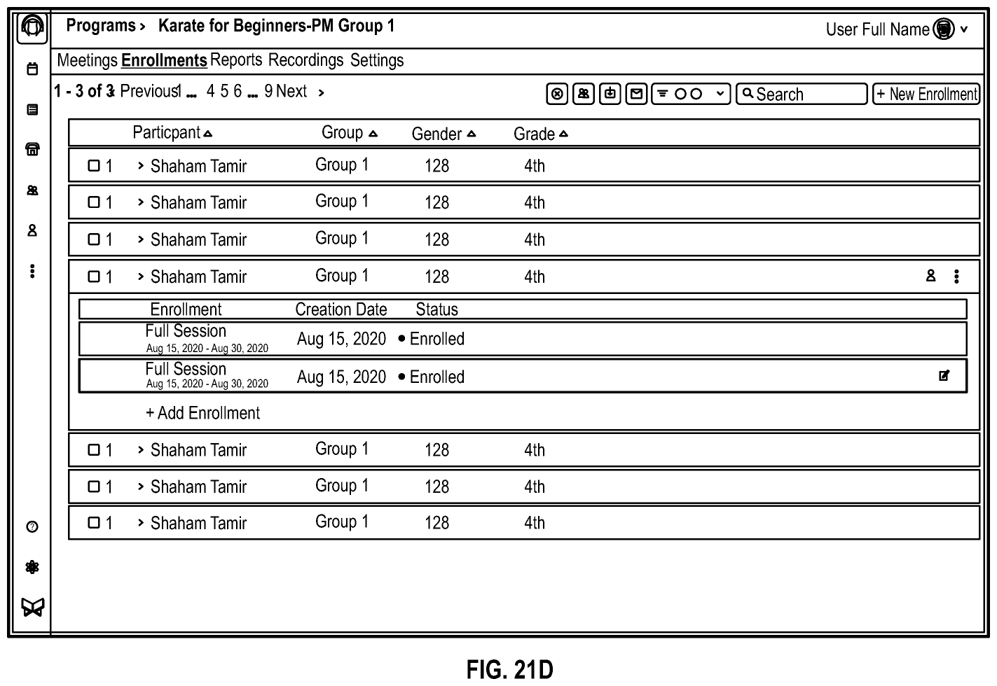

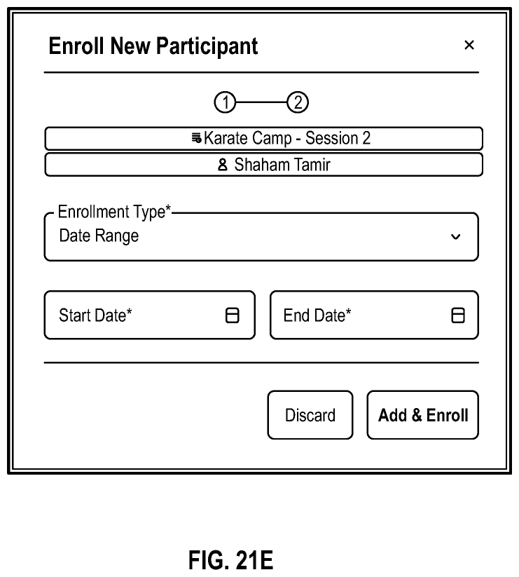

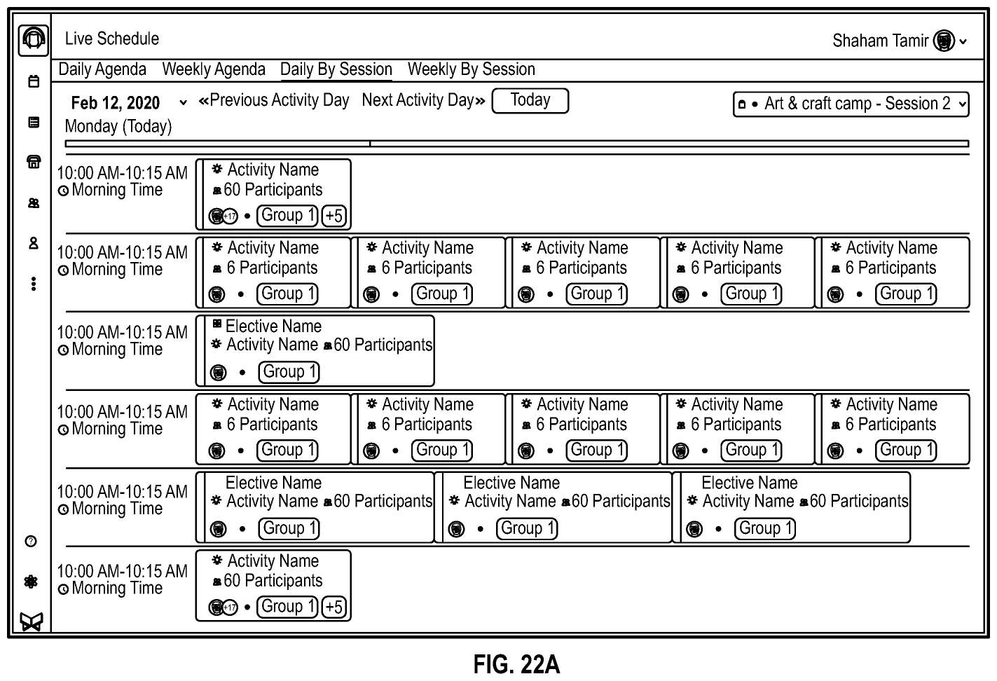

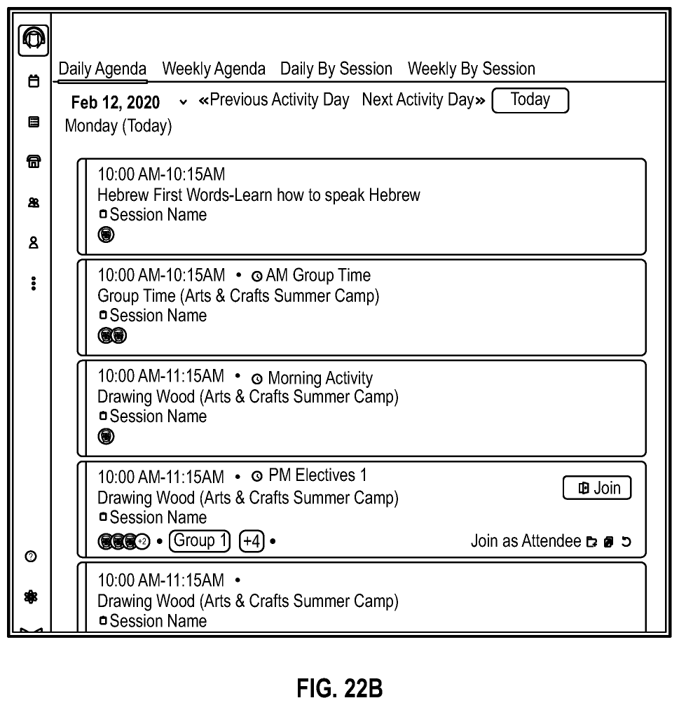

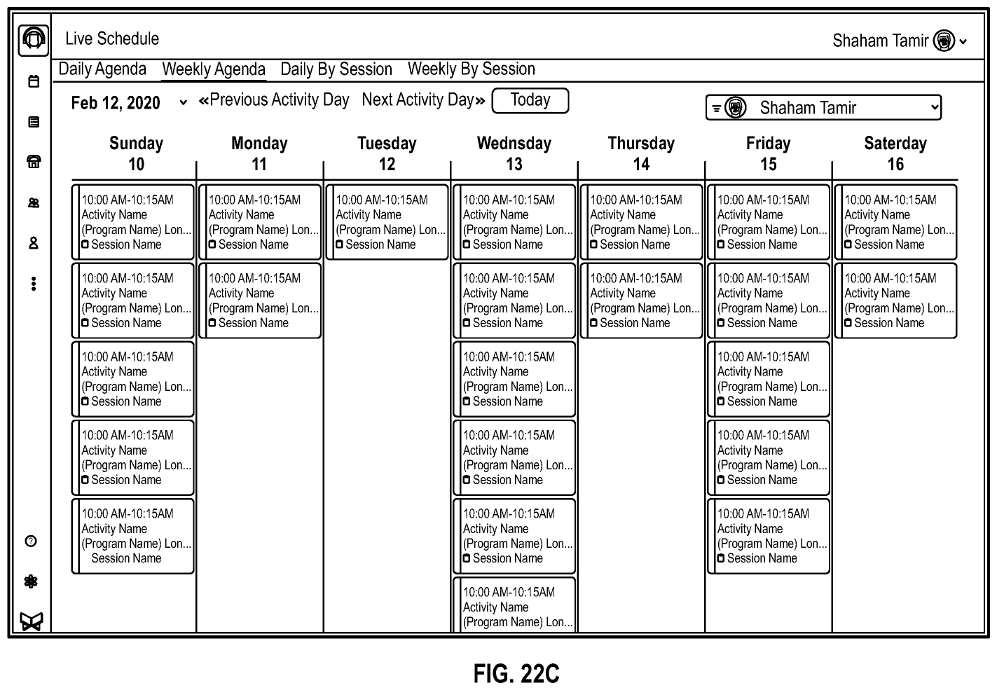

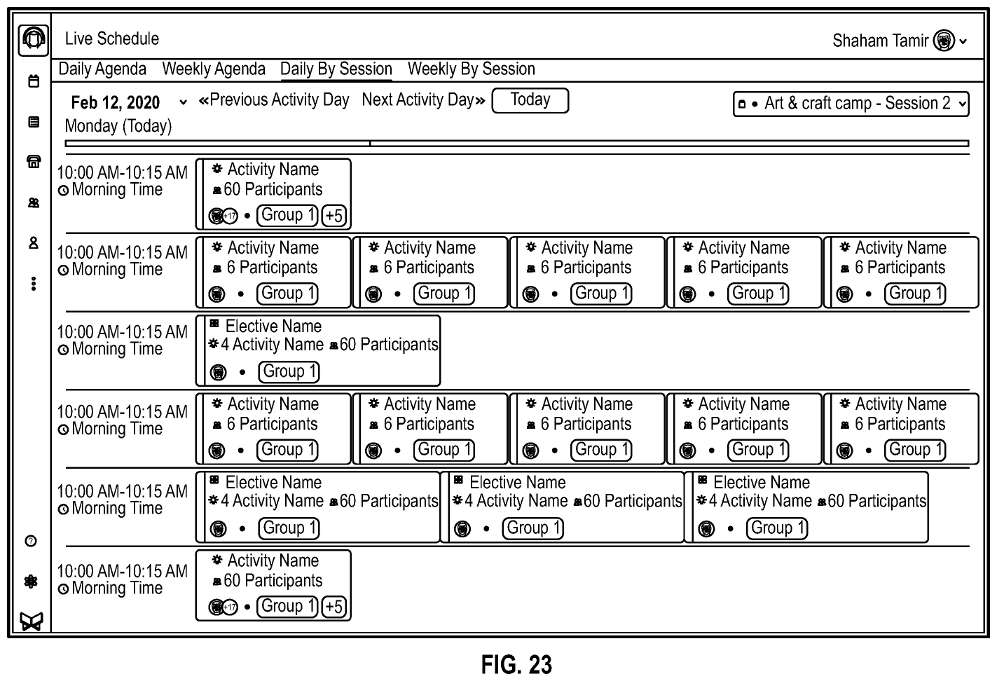

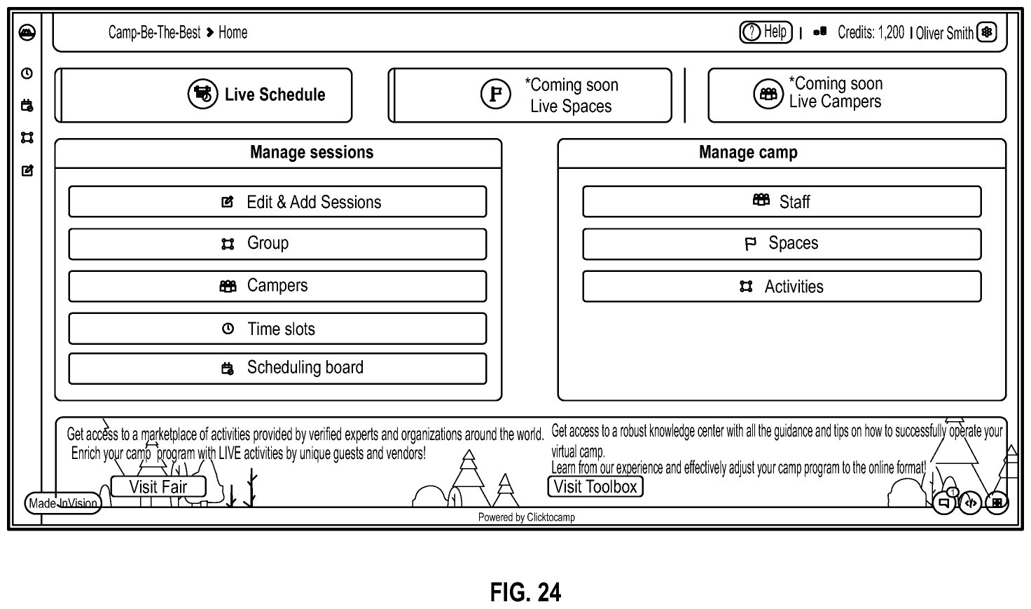

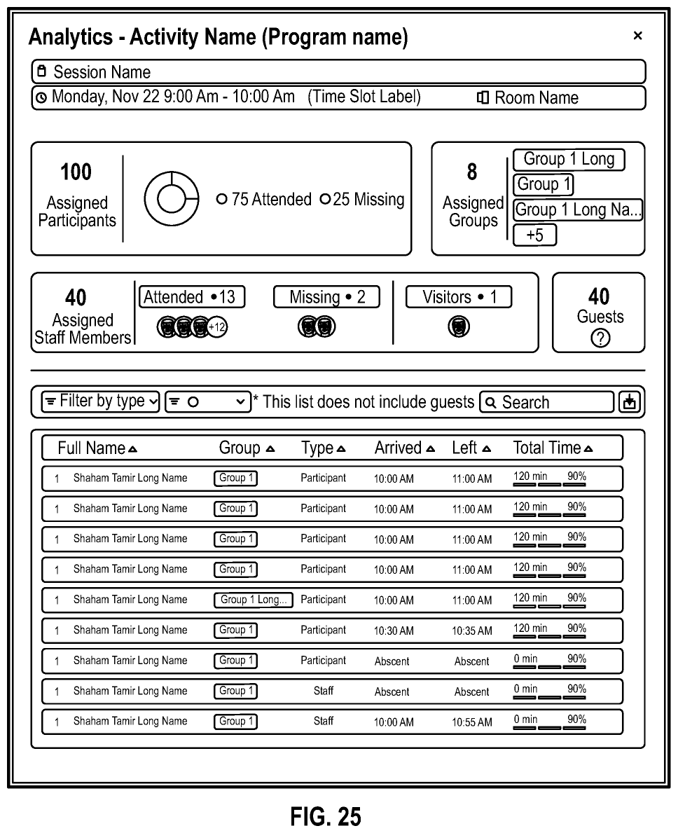

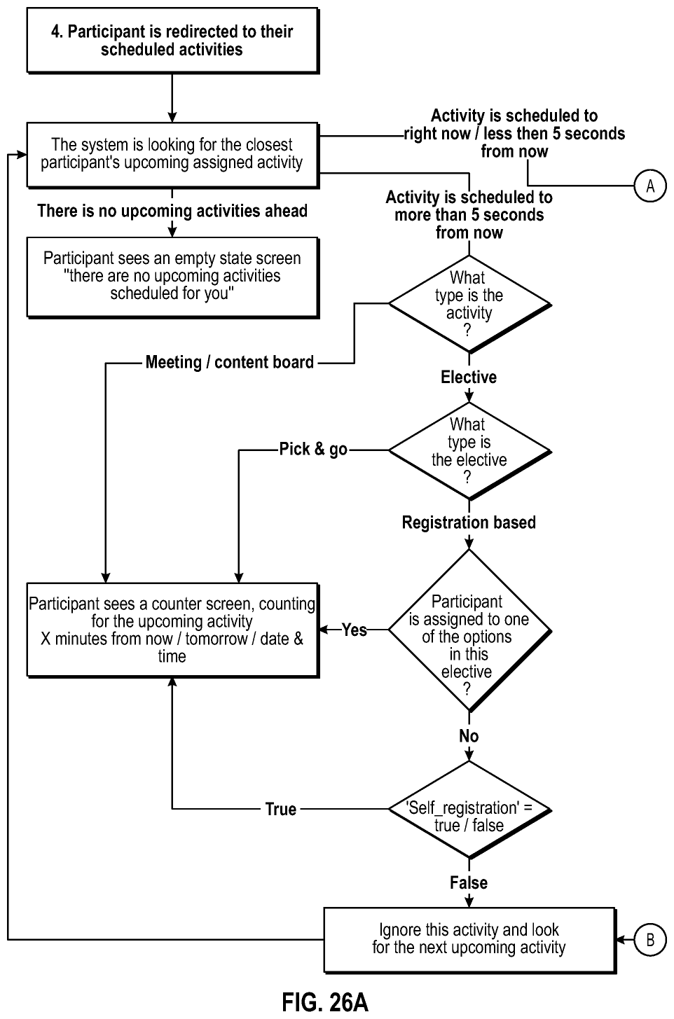

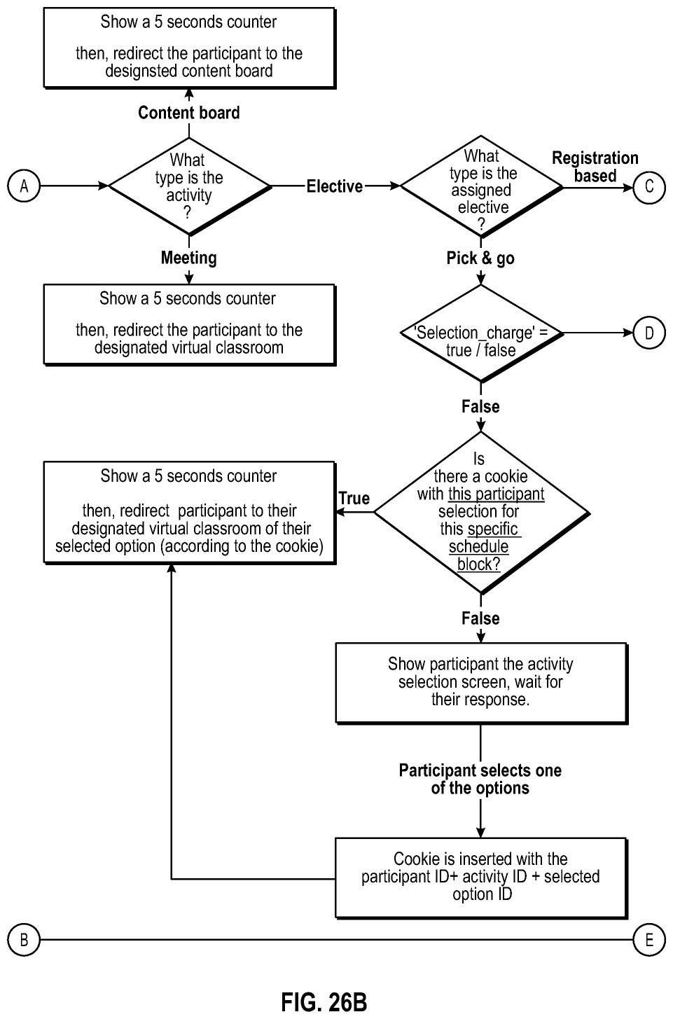

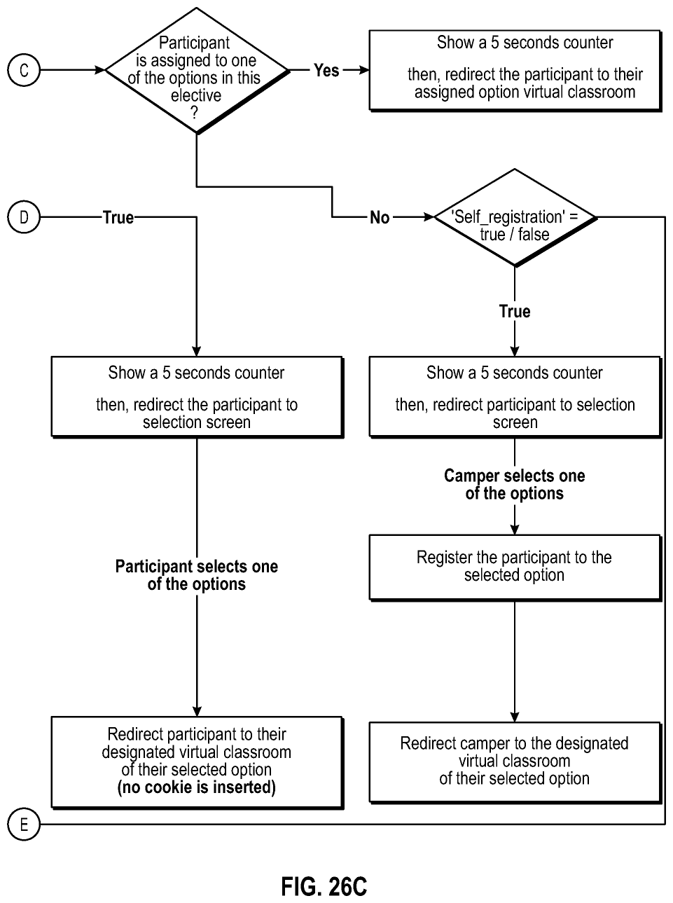

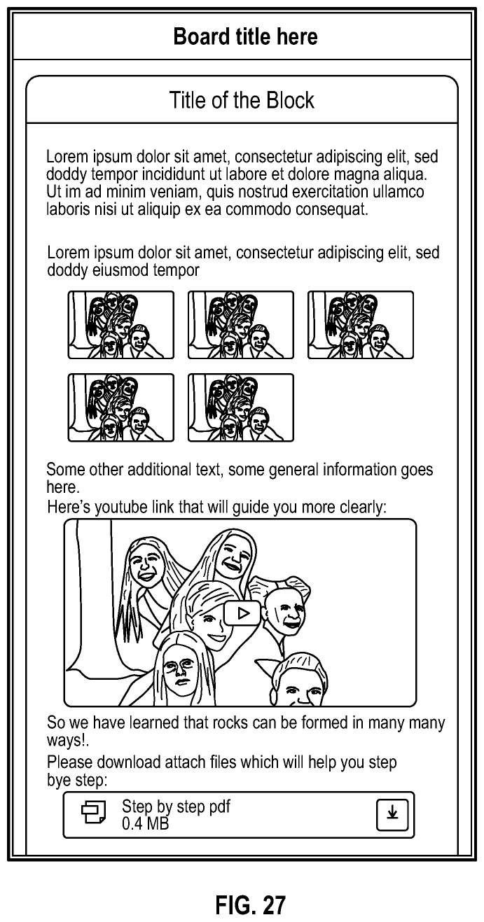

In accordance with some embodiments, the VRPN system may include multiple main consoles or modules, including a Super Admin management console, a program management console (e.g., for a camp or other program), and a program trafficking or navigation management console (e.g., for a camp or other program), as can be seen with reference to FIG. 1. Further, a database structure is provided to support the main consoles.

Further, an example of a workflow for a staff member log in is shown in FIG. 2.

Further, an example of a workflow for adding a staff member is shown in FIG. 3.

Further, an example of a workflow for editing a staff member is shown in FIG. 4.

Further, an example of a workflow for deleting a staff member is shown in FIG. 5.

Further, an example of a workflow for adding a virtual space is shown in FIG. 6.

Further, an example of a workflow for entering a virtual space as a guest is shown in FIG. 7.

Further, an example of a workflow for adding an activity is shown in FIG. 8.

Further, an example of a workflow for activating a session is shown in FIG. 9.

In some embodiments, the VRPN system may feature “Admin” level users. The admin creates the assets of the program, on the management screens.

They may be required to add “spaces” which represent virtual rooms, activity types, program sessions, staff users, groups, and time slots. A screenshot of an example of an admin type GUI dashboard can be seen in FIG. 10. As can be seed, admin users may be required to add participants and assign them to a specific group.

On the scheduling board screen, admin users may be required to assign for each group the spaces and activities for the desired time slots. Screenshots of examples of scheduling board GUI's can be seen in FIGS. 11A-11D.

According to some embodiments, Admin can schedule meetings for all the enrolled participants of a session, quickly & easily, from the session management area. After scheduling meetings to groups/courses, the participants may automatically be assigned to these meetings. The participants may be automatically redirected to these meetings after they enter their personal access link. When the meeting will end, the participants may automatically be redirected to their personal access link, which, if they have another meeting scheduled, may again redirect them to their next activity.

In one example, for daily schedule programs: the user may navigate to the ‘Scheduling Board’ screen inside the desired session area. The user may add activity days, time slots during the day & groups. The user may see the matrix of time slots and groups per each day. The user may schedule an activity for every group during each of the time slots. The users may also assign a room (virtual classroom) for each schedule. A schedule may be changed at any time and will have an immediate effect on the participants personal area and on the live schedule for the counselors. The scheduling board may allow the admin to control all of the participant's assignments.

In another example, for course programs: the user may navigate to the ‘Meetings’ screen inside the desired session area. Further, the user may add: A Single meeting, by choosing the date, start time and end time; and/or by choosing a dedicated virtual classroom for the meeting. Further the user may add a Recurring meeting, wherein the user may choose the weekday, date range, start & end time; choose to eliminate undesired meetings from the generated list; and/or choose a dedicated virtual classroom for the meeting.

Further, as can be seen in FIGS. 12-16, screenshots of examples of scheduling content boards or functions are shown, according to some embodiments. According to some embodiments, content boards may be pages, filled with content made out of rich text, media and other types of components. Staff members can create content boards which they can share with their students/schedule during a designated asynchronous learning time. Furthermore: a user may schedule a content board instead of a meeting; from the scheduling board, the user chooses a group and time slot and then chooses ‘Content board’ from the modal or popup; a user may assign any of the existing content board on the account; content boards may be edited by all staff members of the account; content boards may contain rich text & media; participants may have access to a scheduled content board only during the time slot which it is assigned for. For example, when the time is finished, they may be redirected to a user personal access link.

According to some embodiments, an Electives module may allow participants of the same group to participate in different activities during a designated time slot, according to the participants choice of activity or following by a registration process.

Further, as can be seen in FIGS. 17A-17B, screenshots of examples of setting and scheduling electives are shown, according to some embodiments.

In some examples, a user navigates into the electives screen of the desired session: User may create new elective; User can add different activities options, for each option user needs to specify the virtual classroom in which the activity will be held; User may be required to choose the type of elective.

Type of electives may include, in some cases: Pick & go—by selecting this option, when participants are redirected into the elective, they may see the full list of activities offered during the elective. Then they may be able to choose in which activity they wish to participate; and Pre-registration: By selecting this option, the user may need to specify which participants are registered for each option. Further, the participants may automatically be sent to the option they are registered to. Additionally, the user can also check the option of self-registration, which get the participants to register themselves into one of the options on the first time they are sent to this elective.

In some examples, the user may then navigate into the scheduling board screen, the user chooses a group and time slot and then chooses ‘elective’ from the modal tabs. The User may select any elective from the list.

In further embodiments, Admin users may be required to activate a session, and ask the system to automatically send all participants an email with their unique participation link (SPL).

Admin users may further be required to provide Credits for activating a session. Credits can optionally be purchased on a Pay As You Go basis.

In some embodiments, the VRPN system may feature “staff” level users. The staff has access to a screen showing the rooms assigned for each time slot, and for each one a list of groups assigned to that schedule block. The staff user can click on a room, and the system will automatically log them into that room with their name and with a meeting host privilege.

As can be seen, when a user clicks the link, they may be shown an appropriate screen. If they are scheduled to an activity that takes place right now, or when it's time for their next activity, they are being redirected and logged in automatically (without additional clicks) to the virtual room their group is assigned to for this activity.

According to some embodiments, the system, platform and methods described herein may provide a Personal Access Link (PAL) function, for example, where each participant has a unique personal access link. By entering the link, the system may authenticate the participant on the device so they will get to their personal area with ease. Participants may be assigned to different meetings according to their session enrollments. If there are any meetings occurring during a participant's enrollment period, the participant may be assigned to those meetings. Participant may be assigned to activities from different sessions. After authentication (via PAL), participants may get to their personal area. The personal area may always show the upcoming meeting details/redirect the participant into a scheduled meeting/board if they are happening currently. When a meeting/board time ends, the user may be redirected into their personal area once again, according to their PAL authentication. Other functions or features related to the PAL may be provided.

Detailed best-case examples of PAL creation and usage a system workflow are shown in FIGS. 18-20, according to some embodiments. As can be seen, in FIG. 18 an example of steps is shown to enable the creating of a new participant in the back office, where each participant is provided with their Personal Access Link.

As can be seen, in FIG. 19, an example of steps is shown to enable the participant to open their Personal Access Link. As can be seen, the system verifies and authenticates the participant, and thereafter the user's #Hash is saved in the local storage to keep the user authenticated. Further, participants may be redirected to the personal area screen to view their customized page with personal information and upcoming meetings or activities.

As can be seen, in FIG. 20, an example of steps is shown to enable the participant to Logout of the system or out of one or more sessions. As can be seen, the user may be logged out altogether, for example if there is an authentication issue or if a session or program finishes. In other cases, the user may end a session and be redirected to their personal area, to optionally continue participation in the platform or in other sessions, upon suitable authentication.

According to some embodiments, a participant can choose different enrolment types or options, according to which the admin may customize the scheduling in groups, and can manage the user access to platform features, functions or sessions. As can be seen, in FIG. 21, a detailed workflow example shows steps that may be taken to enable the smart enrolment of users. As can be seen, new programs and program types may be created for a user, in accordance with the enrolment types selected.

Further, as can be seen in FIGS. 21B-21E, screenshots of examples of setting and scheduling enrollments are shown, according to some embodiments;

Enrollments are a linking element between participants and sessions. The enrollments of a participant are defining the meetings/boards which the participant will be assigned to during a specific session. In some examples, a participant can be enrolled to any of the existing sessions of the account.

In some embodiments, enrollment can be set to be for a: Full session—meaning the participant will be assigned to all the meetings of the session; Date range—meaning the participant will be assigned to all the meetings held in the session between a specified start & end date; Drop in—meaning the participant will be assigned to a specific meeting during the session.

In some cases, participants can be enrolled multiple times to the same session. For example: participant can be enrolled to 2 different date ranges during the same session, or to different drop-ins during the same session.

According to certain embodiments, the VRPN can also be used for hosting or participating in virtual Hackathons, virtual company events, virtual conferences. Some educational programs run a virtual program alongside with an in-person program. The VRPN, in further embodiments, may also be used to represent the complete schedule of the virtual groups and the in-person groups.

According to some embodiments, a live scheduling module is provided. In some examples, the staff and/or participants can use the Live Schedule board to see the different rooms and their group assignments, for each time slot. Users can click on a room, in order to log in automatically to that room. Screenshots of examples of Live Schedule related GUI's can be seen in FIGS. 22A-22C, 23 and 24.

In some embodiments a Live Schedule function is provided. In some examples, the live schedule may be a screen dedicated for the staff members and administration which is designed to show the user his/her assigned meetings and allow them to join the meeting, watch analytics & recordings, and see the meetings details, including its assigned participants etc.

In some cases, the live schedule can be filtered by a staff member, participant, virtual classroom, etc. For example, Live schedule may have the following views: A Daily Agenda—Presents all the meetings of a selected date; A Weekly Agenda—Presents all the meetings of a selected week; and A Daily session view—Presents all the meetings of a specific session during a selected date. This view is designed to suit daily schedule programs.

In some embodiments, the VRPN system may feature “participant” level users. The participant receives a unique participation link to their email.

FIG. 25 shows an example of a screenshot showing a sample Analytics type attendance report for admins, according to some embodiments.

FIGS. 26A-26C shows an example of a screenshot showing a sample content board, according to some embodiments.

As can be seen, in FIG. 27, an example of steps is shown to setup and enable the participant to be directed or navigated to their scheduled activities. As can be seen, one or more of the steps described enable the user may be smartly directed to their designated virtual classroom, referred to hereinafter as live scheduling.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system for facilitating virtual meetings, comprising:
a system management console;
a program management console; and
a participant navigation module,
wherein the system management console provides a user with a single personalized link (SPL), and
wherein the program management console provides automated access to multiple secured virtual meetings as per the participant's selected schedule, using the SPL, and
wherein the participant navigation module enables automated transfers of the user to appropriate virtual meetings based on the participant's predefined schedule.

2. The system of claim 1, further comprising a payment module for facilitating payment of virtual meeting enrolment according to participant selections, wherein the participant navigation module is adapted to allow or refuse participant entry to virtual meetings in accordance with the payment for virtual meeting enrolment.

3. The system of claim 1, further comprising code to run in the background of all user activities to determine user authentication for attendance to a current activity.

4. The system of claim 1, further comprising a plug and play Application to be run on a browser of a communications device to facilitate registration, scheduling, attendance and management of virtual meetings.

5. The system of claim 1, further comprising a downloadable dedicated software Application to be run on a smart communications device to facilitate registration, scheduling, attendance and management of virtual meetings.

6. A platform for managing live scheduling of virtual activities, comprising:
an electives module;
a module providing scheduled content boards;
a module enabling participation on demand; and
a module for enabling partial participant assignments.

7. A method for managing attendance of virtual programs, comprising:
creating a new participant in a virtual program system, and providing the new participant with a Personal Access Link (PAL);
scheduling one or more activities for the participant, based on the participant's selected program type;
enrolling the participant, based on the participant's enrolment type;
providing the participant with a virtual program entrance page for entering of PAL;
verifying and authenticating the user's PAL prior to allowing participant entry into the virtual program;
redirecting the participant to one or more virtual meeting rooms, based on the participant's schedule; and
logging the participant out of a virtual program when the participant enrolment determines such, by disactivating the user PAL.

8. The method of claim 7, wherein a user Application is provided that facilitates automatic transfers between meetings according to participant schedules.

9. The method of claim 7, wherein a user Application is provided that facilitates user customized enrolment into one or more of virtual meetings, virtual programs, and virtual camps.

10. The method of claim 7, wherein a user Application is provided that facilitates user payment for selected meetings or programs.

11. The method of claim 7, wherein a user Application is provided that facilitates user payment based on user participation in one or more virtual meetings or programs.
